(19) United States
(12) Patent Application Publication
(10) Pub. No.: US 2017/0358170 A1
(43) Pub. Date: Dec. 14, 2017

(54) DRAWING GAME SYSTEM, METHOD AND PROGRAM

(71) Applicant: KONAMI DIGITAL ENTERTAINMENT CO., LTD., Tokyo (JP)

(72) Inventors: Shinya ITO, Tokyo (JP); Kensaku YOSHIDA, Tokyo (JP); Fumihito OGUCHI, Tokyo (JP); Fumitaka TAKEYAMA, Tokyo (JP); Junichi SASA, Tokyo (JP); Ken SASAKI, Tokyo (JP); Hiroshi HAYASHI, Tokyo (JP)

(73) Assignee: KONAMI DIGITAL ENTERTAINMENT CO., LTD., Tokyo (JP)

(21) Appl. No.: 15/594,742

(22) Filed: May 15, 2017

(30) Foreign Application Priority Data
Jun. 8, 2016 (JP) 2016-114826

(51) Int. Cl. G07F 17/32

(52) U.S. Cl. CPC G07F 17/329; G07F 17/3239; G07F 17/3258

(57) ABSTRACT

A drawing game system includes a drawing device, a drawing reward granting device, an association device, and an association reward granting device. The drawing device may be configured to draw for one or more players a choice from among two or more choices. The drawing reward granting device may be configured to grant the one or more players with a drawing reward, based at least in part on the choice drawn by the drawing device. The association device may be configured to associate the one or more players with the choice drawn by the drawing device. The association reward granting device may be configured to grant the one or more players with an association reward, in case that after the choice was associated by the association device, the choice has been drawn by the drawing device.

### TECHNICAL FIELD

Embodiments of the present invention generally relate to a drawing game system, method, and program.

### BACKGROUND ART

Japanese Patent Application Publication No. 2009-142631 discloses a gaming machine configured to reset the value of a jackpot reward to an initial value if a plurality of players accumulates rewards by bets, so that one of the players receives the accumulated rewards, hereinafter sometimes recited as a jackpot reward. In a gaming machine such as noted above, because, for example, immediately after the jackpot reward value is reset to the initial value, the attractiveness of the reward decreases, there can be caused a decrease in the number of players wanting to participate in the drawing game. Even in game devices other than ones that handle accumulation-type jackpot rewards, there can be caused a difficulty in providing motivation for participation in the drawing game before other players play.

### SUMMARY

In some aspects, a drawing game system may include, but is not limited to, a drawing device, a drawing reward granting device, an association device, and an association reward granting device. The drawing device may be configured to draw for one or more players a choice from among two or more choices. The drawing reward granting device may be configured to grant the one or more players with a drawing reward, based at least in part on the choice drawn by the drawing device. The association device may be configured to associate the one or more players with the choice drawn by the drawing device. The association reward granting device may be configured to grant the one or more players with an association reward, in case that after the choice was associated by the association device, the choice has been drawn by the drawing device.

### BRIEF DESCRIPTION OF THE DRAWINGS

FIG. 1 is a diagram showing an example of the overall configuration of a game system in the embodiment.

FIG. 2 is a schematic perspective view showing an example of the outer appearance of a game machine in the embodiment.

FIG. 3 is a schematic perspective view showing a structural part of a pusher game machine in the embodiment.

FIG. 4 is a schematic perspective view showing the structural part of a pusher game machine in the embodiment.

FIG. 5 is a schematic perspective view showing the structural part of a pusher game machine in the embodiment.

FIG. 6 is a view showing an example of the jackpot drawing screen in the embodiment.

FIG. 7 is a view showing a ball drawer, seen in plan view, in the embodiment.

FIG. 8 is a view showing an example of roulette wheels in the embodiment.

FIG. 9 is a block diagram showing an example of the configuration of a game machine in the embodiment.

FIG. 10 is a block diagram showing an example of the configuration of a center server in the embodiment.

FIG. 11 is a view showing an example of the structure of player information in the embodiment.

FIG. 12 is a view showing an example of the structure of ground setting information in the embodiment.

FIG. 13 is a view showing an example of the structure of character position information in the embodiment.

FIG. 14 is a view showing an example of the structure of drawing reward information in the embodiment.

FIG. 15 is a view showing an example of the structure of association reward information in the embodiment.

FIG. 16 is a flowchart showing an example of the processing procedure executed regarding a jackpot drawing by a game machine in the embodiment.

### DETAILED DESCRIPTIONS

In some aspects, a drawing game system may include, but is not limited to, a drawing device, a drawing reward granting device, an association device, and an association reward granting device. The drawing device may be configured to draw for one or more players a choice from among two or more choices. The drawing reward granting device may be configured to grant the one or more players with a drawing reward, based at least in part on the choice drawn by the drawing device. The association device may be configured to associate the one or more players with the choice drawn by the drawing device. The association reward granting device may be configured to grant the one or more players with an association reward, in case that after the choice was associated by the association device, the choice has been drawn by the drawing device.

In some cases, the association device may be configured to associate the one or more players with the choice drawn by the drawing device in case that a predefined association enabling condition is satisfied.

In some cases, the drawing device is configured to draw a respective choice for each of players. The predefined association enabling condition includes at least a condition that the number of players that are associated with the choice or choices drawn by the drawing device is less than a predefined threshold.

In some cases, the association device may be configured to associate the one or more players with the choice drawn by the drawing device in case that a predefined association enabling condition is satisfied. The drawing game system may include, but is not limited to, an identification acquisition device configured to acquire an identification of a player. The predefined association enabling condition includes at least a condition that the identifications of the one or more players are acquired by the identification acquisition device.

In some cases, the drawing device is configured to draw a respective choice for each of players. The predefined association enabling condition includes at least a condition that the number of players that are associated with the choice or choices drawn by the drawing device is less than a predefined threshold. The drawing game system may include, but is not limited to, an identification acquisition device configured to acquire an identification of a player. The predefined association enabling condition includes at least a condition that the identifications of the one or more players are acquired by the identification acquisition device.

In some cases, the drawing game system may include, but is not limited to, an association breaking device configured to break all or part of associations that were made by the association device, in case that a predetermined association breaking condition is satisfied.

In some cases, the association device may be configured to associate the one or more players with the choice drawn by the drawing device in case that a predefined association enabling condition is satisfied. The drawing game system may include, but is not limited to, an association breaking device configured to break all or part of associations that were made by the association device, in case that a predetermined association breaking condition is satisfied.

In some cases, the association device may be configured to associate the one or more players with the choice drawn by the drawing device in case that a predefined association enabling condition is satisfied. The drawing game system may include, but is not limited to, an identification acquisition device configured to acquire an identification of a player. The predefined association enabling condition includes at least a condition that the identifications of the one or more players are acquired by the identification acquisition device. The drawing game system may include, but is not limited to, an association breaking device configured to break all or part of associations that were made by the association device, in case that a predetermined association breaking condition is satisfied.

In some cases, the association device may be configured to associate the one or more players with the choice drawn by the drawing device in case that a predefined association enabling condition is satisfied. The drawing game system may include, but is not limited to, an identification acquisition device configured to acquire an identification of a player. The predefined association enabling condition includes at least a condition that the identifications of the one or more players are acquired by the identification acquisition device. The drawing game system may include, but is not limited to, an association breaking device configured to break all or part of associations that were made by the association device, in case that a predetermined association breaking condition is satisfied.

In some cases, the drawing device is configured to draw a respective choice for each of players. The predefined association enabling condition includes at least a condition that the number of players that are associated with the choice or choices drawn by the drawing device is less than a predefined threshold. The drawing game system may include, but is not limited to, an identification acquisition device configured to acquire an identification of a player. The predefined association enabling condition includes at least a condition that the identifications of the one or more players are acquired by the identification acquisition device. The drawing game system may include, but is not limited to, an association breaking device configured to break all or part of associations that were made by the association device, in case that a predetermined association breaking condition is satisfied.

In some cases, the drawing game system may include, but is not limited to, an association breaking device configured to break all or part of associations that were made by the association device, in case that a predetermined association breaking condition is satisfied. The association breaking device is configured to break all or part of associations that were made by the association device, in case that the predetermined association breaking condition is satisfied. The predefined association enabling condition includes at least a condition that a predefined specific choice is drawn by the drawing device.

In some cases, the drawing game system may include, but is not limited to, an association breaking device configured to break all or part of associations that were made by the association device, in case that a predetermined association breaking condition is satisfied. The association breaking device is configured to break all or part of associations that were made by the association device, in case that the predetermined association breaking condition is satisfied. The predefined association enabling condition includes at least a condition that a predefined specific choice is drawn by the drawing device. At least part of choices to be drawn by the drawing device corresponds to a variable reward to be granted by the drawing reward granting device. The drawing reward granting device is configured to grant the one or more players with the variable reward and to re-set a value of the variable reward into an initial value of the variable reward, in case that the at least part of choices corresponding to the variable reward was drawn by the drawing device. The association breaking device is configured to break all or part of associations that were made by the association device, in case that the predetermined association breaking condition is satisfied, which includes at least a condition that the value of the variable reward is re-set by the drawing reward granting device into an initial value of the variable reward.

In some cases, the association device may be configured to associate the one or more players with the choice drawn by the drawing device in case that a predefined association enabling condition is satisfied. The drawing game system may include, but is not limited to, an association breaking device configured to break all or part of associations that were made by the association device, in case that a predetermined association breaking condition is satisfied. The association breaking device is configured to break all or part of associations that were made by the association device, in case that the predetermined association breaking condition is satisfied. The predefined association enabling condition includes at least a condition that a predefined specific choice is drawn by the drawing device.

In some cases, the association device may be configured to associate the one or more players with the choice drawn by the drawing device in case that a predefined association enabling condition is satisfied. The drawing game system may include, but is not limited to, an association breaking device configured to break all or part of associations that were made by the association device, in case that a predetermined association breaking condition is satisfied. The association breaking device is configured to break all or part of associations that were made by the association device, in case that the predetermined association breaking condition is satisfied. The predefined association enabling condition includes at least a condition that a predefined specific choice is drawn by the drawing device. At least part of choices to be drawn by the drawing device corresponds to a variable reward to be granted by the drawing reward granting device. The drawing reward granting device is configured to grant the one or more players with the variable reward and to re-set a value of the variable reward into an initial value of the variable reward, in case that the at least part of choices corresponding to the variable reward was drawn by the drawing device. The association breaking device is configured to break all or part of associations that were made by the association device, in case that the predetermined association breaking condition is satisfied, which includes at least a condition that the value of the variable reward is re-set by the drawing reward granting device into an initial value of the variable reward.

In some cases, the association device may be configured to associate the one or more players with the choice drawn by the drawing device in case that a predefined association enabling condition is satisfied. The drawing game system may include, but is not limited to, an identification acquisition device configured to acquire an identification of a player. The predefined association enabling condition includes at least a condition that the identifications of the one or more players are acquired by the identification acquisition device. The drawing game system may include, but is not limited to, an association breaking device configured to break all or part of associations that were made by the association device, in case that a predetermined association breaking condition is satisfied. The association breaking device is configured to break all or part of associations that were made by the association device, in case that the predetermined association breaking condition is satisfied. The predefined association enabling condition includes at least a condition that a predefined specific choice is drawn by the drawing device.

In some cases, the association device may be configured to associate the one or more players with the choice drawn by the drawing device in case that a predefined association enabling condition is satisfied. The drawing game system may include, but is not limited to, an identification acquisition device configured to acquire an identification of a player. The predefined association enabling condition includes at least a condition that the identifications of the one or more players are acquired by the identification acquisition device. The drawing game system may include, but is not limited to, an association breaking device configured to break all or part of associations that were made by the association device, in case that a predetermined association breaking condition is satisfied. The association breaking device is configured to break all or part of associations that were made by the association device, in case that the predetermined association breaking condition is satisfied. The predefined association enabling condition includes at least a condition that a predefined specific choice is drawn by the drawing device. At least part of choices to be drawn by the drawing device corresponds to a variable reward to be granted by the drawing reward granting device. The drawing reward granting device is configured to grant the one or more players with the variable reward and to re-set a value of the variable reward into an initial value of the variable reward, in case that the at least part of choices corresponding to the variable reward was drawn by the drawing device. The association breaking device is configured to break all or part of associations that were made by the association device, in case that the predetermined association breaking condition is satisfied, which includes at least a condition that the value of the variable reward is re-set by the drawing reward granting device into an initial value of the variable reward.

In some cases, the association device may be configured to associate the one or more players with the choice drawn by the drawing device in case that a predefined association enabling condition is satisfied. The drawing game system may include, but is not limited to, an identification acquisition device configured to acquire an identification of a player. The predefined association enabling condition includes at least a condition that the identifications of the one or more players are acquired by the identification acquisition device. The drawing game system may include, but is not limited to, an association breaking device configured to break all or part of associations that were made by the association device, in case that a predetermined association breaking condition is satisfied. The association breaking device is configured to break all or part of associations that were made by the association device, in case that the predetermined association breaking condition is satisfied. The predefined association enabling condition includes at least a condition that a predefined specific choice is drawn by the drawing device.

In some cases, the association device may be configured to associate the one or more players with the choice drawn by the drawing device in case that a predefined association enabling condition is satisfied. The drawing game system may include, but is not limited to, an identification acquisition device configured to acquire an identification of a player. The predefined association enabling condition includes at least a condition that the identifications of the one or more players are acquired by the identification acquisition device. The drawing game system may include, but is not limited to, an association breaking device configured to break all or part of associations that were made by the association device, in case that a predetermined association breaking condition is satisfied. The association breaking device is configured to break all or part of associations that were made by the association device, in case that the predetermined association breaking condition is satisfied. The predefined association enabling condition includes at least a condition that a predefined specific choice is drawn by the drawing device. At least part of choices to be drawn by the drawing device corresponds to a variable reward to be granted by the drawing reward granting device. The drawing reward granting device is configured to grant the one or more players with the variable reward and to re-set a value of the variable reward into an initial value of the variable reward, in case that the at least part of choices corresponding to the variable reward was drawn by the drawing device. The association breaking device is configured to break all or part of associations that were made by the association device, in case that the predetermined association breaking condition is satisfied, which includes at least a condition that the value of the variable reward is re-set by the drawing reward granting device into an initial value of the variable reward.

In other aspects, a drawing game method may include, but is not limited to, drawing for one or more players a choice from among two or more choices; granting the one or more players with a drawing reward, based at least in part on the choice drawn; associating the one or more players with the choice drawn; and granting the one or more players with an association reward, in case that after the choice was associated, the choice has been drawn.

In other aspects, a non-transitory computer readable storage medium that stores one or more computer programs, when executed by one or more computers, cause the one or more computers to perform a drawing game method which may include, but is not limited to, drawing for one or more players a choice from among two or more choices; granting the one or more players with a drawing reward, based at least in part on the choice drawn; associating the one or more players with the choice drawn; and granting the one or more players with an association reward, in case that after the choice was associated, the choice has been drawn.

An embodiment of the present invention is described below, with references made to the drawings.

### Embodiment

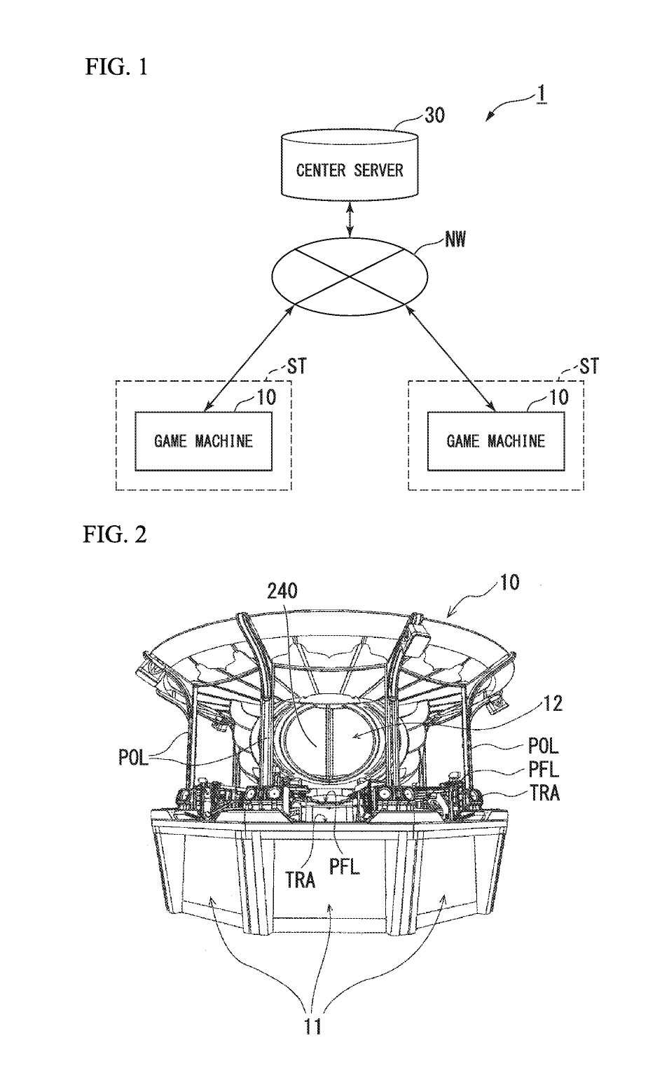

FIG. 1 shows an example of the overall configuration of a game system 1 in the present embodiment. The game system 1 of the present embodiment has a game machine 10 provided in each store ST, and a center server 30. The game machine 10 (an example of a drawing game system) and the center server 30 are connected to enable communication via a network NW.

The game machine 10 of the present embodiment is a commercial game machine that, in exchange for payment of a prescribed playing fee, allows a player to play to the extent of the playing fee. Such a game machine 10 is called an arcade machine, and is installed in a store ST of an amusement facility or the like.

The game machine 10 of the present embodiment uses medals as the playing medium, and is a so-called medal game, into which a player inserts medals to play. In the game machine 10, a pusher game is run as the medal game. In a pusher game, a player inserts a medal onto a medal stand in the game machine 10 and uses the sliding movement of the medal stand, moving the medal stand so as to push it out and drop a medal though a win port, so that the player obtains medals.

The game machine 10 of the present embodiment is made to also run a jackpot game in accordance with the result of the pusher game. A drawing is made by the jackpot game and, if a jackpot is won, the winning player can receive a reward (jackpot reward) in accordance with the progressive value accumulated by the bets of each player.

The center server 30 oversees and manages the game run by the game machine 10. The center server 30, for example, manages the history of games run in the game machine 10 and information of players who play games.

The center server 30 may be constituted as one logical server by the combination of a plurality of server units, or may be constituted as a single server apparatus. Alternatively, the center server 30 may be constituted logically using cloud computing.

In the game system 1, the number of game machines 10 connected to the center server 30 is not particularly limited. That is, there is no particular limitation on the number of stores ST in which a game machine 10 is installed. Also, there is no particular limitation to the number of game machines 10 installed in one store ST.

FIG. 2 shows an example of the outer appearance of the game machine 10 in the present embodiment. The game machine 10 has a plurality of playfields PFL. In each playfield PFL, one player or a plurality of cooperating players can play a game.

The space in which a player plays is delineated by poles POL for each playfield PFL. The space between three neighboring poles is covered by a transparent cover. For that reason, a player cannot directly touch the mechanism in the playfield PFL.

In a playfield PFL, a game such as a pusher game is run by the station unit 11 independently for each playfield PFL. The station unit 11 is provided with a medal receiving tray TRA to which medals won as the result of playing the pusher game are paid out.

In the center of the game machine 10, a center unit 12 is provided. The center unit 12 can rotate about an axis of rotation substantially at the center of the game machine 10 when seen in plan view. The center unit 12 has a plurality of game surfaces arranged in the rotational direction in accordance with prescribed games. In one game surface, as shown in the same drawing, a center display device 240 having a substantially circular display surface is provided.

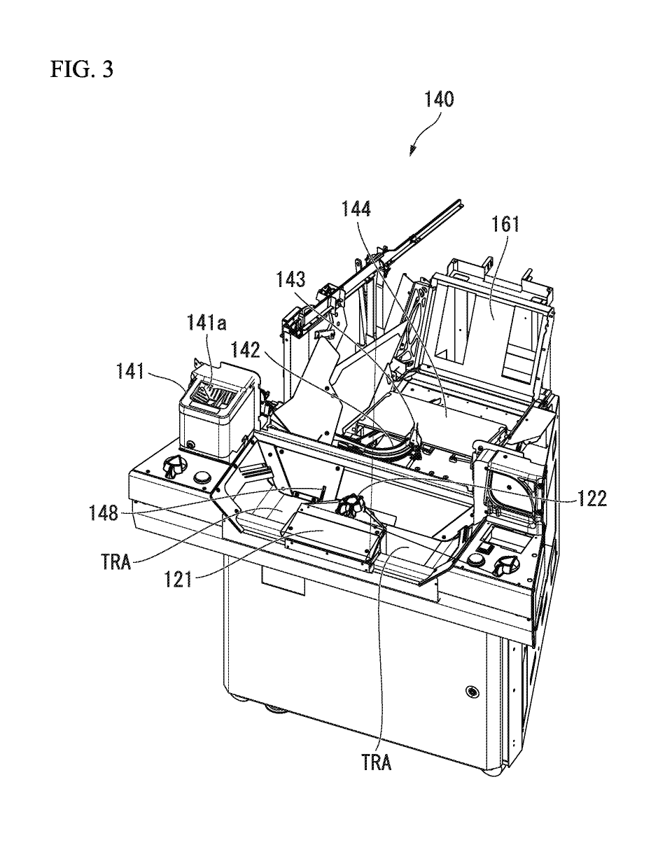

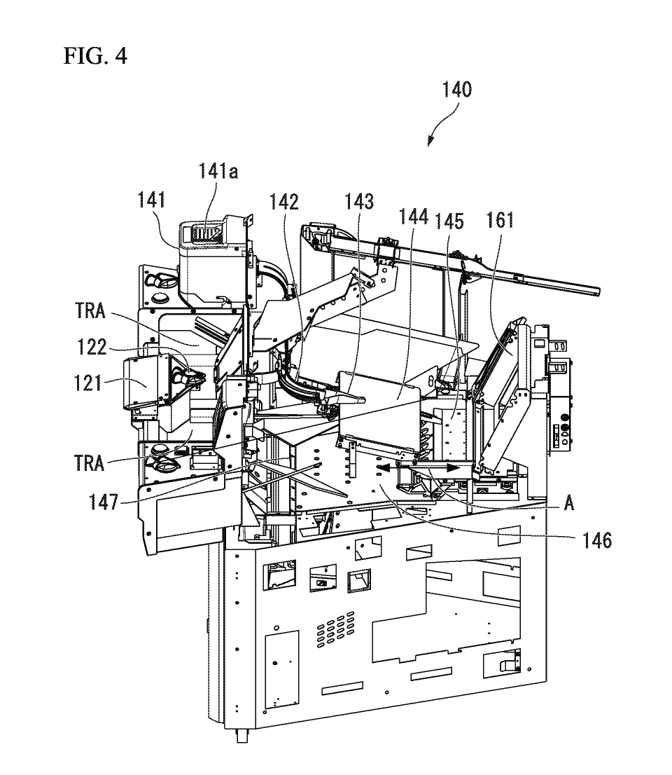

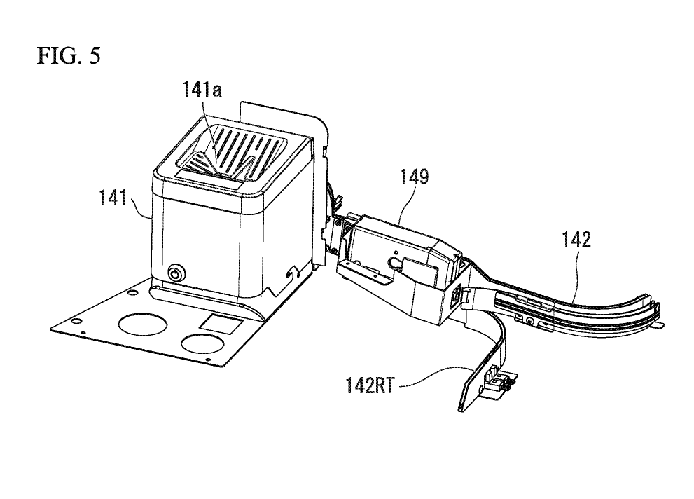

Referring to FIG. 3 to FIG. 5, an example of the configuration of the pusher game machine 140 provided for each station unit 11 in the game machine 10 of the present embodiment will be described. FIG. 3 to FIG. 5 show, in isolation, structural parts of the pusher game machine 140 in one station unit 11. FIG. 3 is an oblique view of the pusher game machine 140 seen from the front, FIG. 4 is an oblique view of the pusher game machine 140 seen from the upper side in the right side surface direction, and FIG. 5 is an oblique isolated view of a part of the medal insertion mechanism.

In describing FIG. 3 to FIG. 5, the side at which a player is positioned with respect to the station unit 11 will be taken to be the front, and the side close to the center unit 12 of the station unit 11 will be taken to be the rear.

Referring to FIG. 3 and FIG. 4, the example of the overall configuration of the pusher game machine 140 will be described.

A medal hopper 141 is provided on front right side of the station unit. A medal filler 141a, which enables bulk insertion of medals, is provided in the medal hopper 141.

A medal insertion switch 121 that is, for example, a rectangular plate, is provided at the top part of the medal receiving tray TRA at the front of the station unit.

When the medal insertion switch 121 is operated to press it downward, the medal hopper 141 operates to feed out a large number of medals inserted into the medal filter 141a one at a time to a medal insertion rail 142. Then, when the player removes the hand from the medal insertion switch 121 to release the medal insertion switch 121 from the condition in which it is pressed down, the medal hopper 141 stops feeding medals.

The medal insertion rail 142 feeds out medals fed out from the medal hopper 141 so that they roll in the vertical direction and are ejected from the medal ejection port 143 provided at the end of the medal insertion rail 142.

In this case, the medal insertion rail 142 is disposed so that it is fixed in the state in which the end is positioned at the center with respect to left and right of the upper medal stand 145. Additionally, the angle of the medal ejection port 143 provided at the end of the medal insertion rail 142 can be changed in the left-right direction to an arbitrary angle within a certain angle range. The change of the angle is done by the player operating a insertion direction change lever 122.

By a configuration such as this, a player can insert medals while changing timing and direction of inserting medals as desired by the player.

Medals ejected from the medal ejection port 143 drop onto a medal receiving plate 144 disposed below the medal ejection port 143. The medal receiving plate 144 is disposed so as to be inclined downward from the front side toward the rear side. For that reason, medals dropped onto the medal receiving plate 144 move along the inclination of the medal receiving plate 144 toward the rear side and are placed on the upper medal stand 145 by dropping from the rear edge. By providing a medal receiving plate 144 such as this, for example, there is an uncertainty imparted to the path of medals ejected from the medal ejection port 143 until they drop onto the upper medal stand 145, thereby increasing the difficulty level as a pusher game and increasing the interest of the game.

Glass, resin, or the like having transparency is used for the medal receiving plate 144. Doing this, the player can make good observation of the state of medals on the upper medal stand 145 and the lower medal stand 146, without blocking by the medal receiving plate 144.

The upper medal stand 145 is made to reciprocate in some established movement range along the front-to-rear direction indicated by the arrow A in FIG. 4, moving with some established timing. When the upper medal stand 145 has moved to the rear, the rearward movement of medals placed on the upper medal stand 145 is restrained. By doing this, the number of medals placed on the upper medal stand 145 increases, with overflowing medals dropping from the front side of the upper medal stand 145 onto the lower medal stand 146 disposed below the upper medal stand 145. Medals placed on the lower medal stand 146 move forward by the forward movement of the upper medal stand 145. Doing this, in accordance with the increase of the number of medals placed on the lower medal stand 146 as well, overflowing medals drop from the front of the lower medal stand 146 onto the lower medal receiver 147.

Medals, having dropped onto the medal receiver 147, are ejected to the medal receiving tray TRA via a prescribed path. The ejected medals are the reward to the player.

That is, the player can play the pusher game by inserting medals placed in the medal hopper 141 onto the upper medal stand 145, so that medals drop onto the medal receiver 147, and are received by the player as a reward. When this is done, the player operates the medal insertion switch 121 and the insertion direction change level 122 while choosing the insertion timing and insertion position so as to receive as many medals as possible as a reward by inserting as few medals as possible.

Medals placed in the medal filler 141a of the medal hopper 141, in accordance with operation of a medal return button provided at a prescribed position on the station unit 11, can be returned to the medal receiving tray TRA side, without being inserted onto the upper medal stand 145.

FIG. 5 shows an example of a mechanism that returns medals from the medal hopper 141 to the medal receiving tray TRA side.

Medals elected from the medal hopper 141 first enter a path selection unit 149. In the state in which the medal return button (not shown) is not operated, the path selection unit 149 is set to a position at which the inserted medals are ejected to the medal insertion rail 142.

In contrast, in the state in which the medal return button has been operated, the path switching unit 149 is set to a position at which the inserted medals are ejected to the medal return rail 142 RT. Medals ejected to the medal return rail 142 RT are guided up to the returned medal ejection port 148, from which they are ejected and returned to the medal receiving tray TRA.

The operator operated for medal return is not restricted to being a button type, and may be, for example, a lever type or the like.

FIG. 3 and FIG. 4 show a station display device mounting frame 161 to which the station display device 160 is mounted. The station display device 160 mounted to the station display device mounting frame 161 is in the state in which it is positioned toward the front of the station unit 11, opposite the player. That is, the station display device 160 is disposed so that a player playing in front of the station unit 11 can see the screen displayed on the station display device 160.

In the game machine 10 in the present embodiment, in the process of running a pusher game at one station unit 11, in response to obtaining a specific game result, a jackpot drawing game starts. The jackpot drawing game is a game in which a player can get a reward in accordance with a progressive value that was won by the drawing. An overview of the jackpot drawing game in the present embodiment is described below.

In accordance with a specific game result based on the progress in the pusher game, a trigger for a jackpot drawing is issued. In response to the issuing of a trigger for a jackpot drawing, the game machine 10 rotates the center unit 12 so that the center display device 240 faces the station unit 11 at which the jackpot drawing trigger had been issued. Doing this, the game machine 10 causes the center display device 240 to display a jackpot drawing screen.

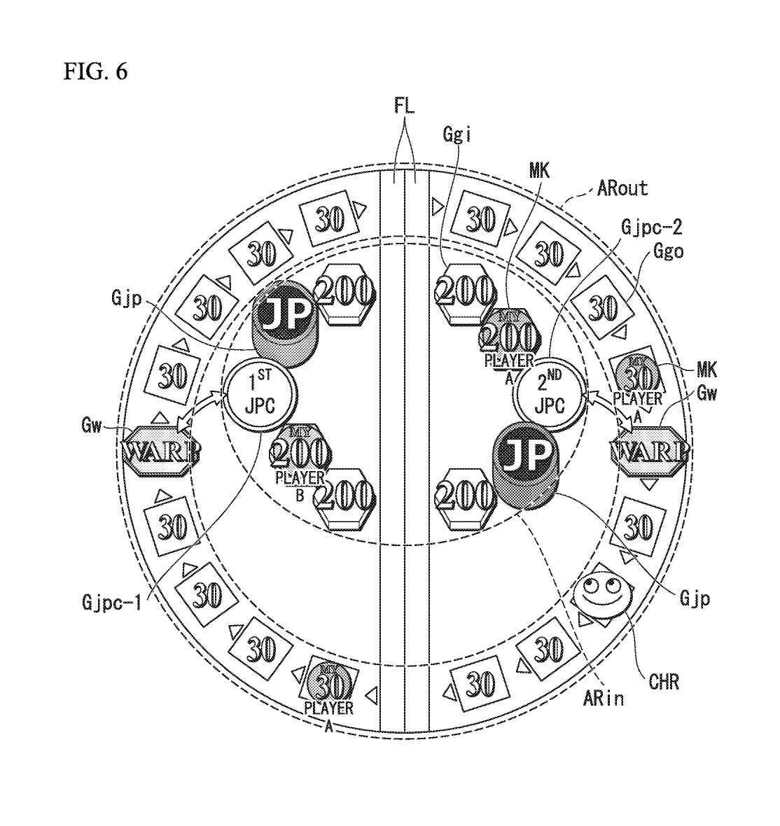

FIG. 6 shows an example of the jackpot drawing screen displayed on the center display device 240. In the center display device 240, a physical frame FL is disposed along the vertical direction in the center of the display surface in the left-to-right direction. For that reason, the frame FL is positioned in the center of the jackpot drawing screen.

The jackpot drawing screen in the this drawing has an outer peripheral area ARout and an inner peripheral area Arin.

The outer peripheral area ARout has disposed therein in a circular peripheral manner a plurality of boxes (examples of choices). The outer peripheral area ARout has disposed therein two types of boxes, the outer periphery general box Ggo and the warp box G2. Mainly outer periphery general boxes Ggo are disposed in the outer peripheral area ARout. This drawing shows an example in which 16 outer periphery general boxes Ggo are disposed. Having done this, one warp box Gw is disposed at each of two positions in the outer peripheral area ARout that are substantially symmetrically opposing positions.

Each of the outer periphery general boxes Ggo is allocated a number of points. In this drawing, the outer periphery general boxes Ggo are uniformly allocated 30 points each. The number of points allocated to each of the outer periphery general boxes Ggo need not be the same, and a plurality of numbers of points can be allocated thereto.

Warp boxes Gw are boxes that can move from the outer peripheral area ARout to the inner peripheral area Arin.

The numbers of and positional relationships between the outer periphery general boxes Ggo and warp boxes Gw disposed in the outer peripheral area ARout may be changed as is appropriate.

The inner peripheral area ARin has disposed therein in a circular peripheral manner a plurality of boxes. There are three types of boxes disposed in the inner peripheral area Arin, inner periphery general boxes Ggi, jackpot challenge boxes Gjpc (first jackpot challenge box Gjpc−1 and second jackpot challenge box Gjpc−2), and jackpot boxes Gjp.

The inner periphery boxes Ggi are the most numerous in the inner peripheral area Arin, and this drawing shows an example in which there are six disposed. Each of the inner periphery boxes Ggi has a number of points allocated to it. This drawing shows an example in which the inner periphery general boxes Ggi are uniformly allocated 200 points each. Comparing the number of points allocated to the outer periphery general boxes Ggi with the number of points allocated to the outer periphery general boxes Ggo, the inner periphery boxes Ggi are set to be higher. The number of points allocated to each of the outer periphery boxes Ggo need not be the same, and a plurality of numbers of points can be allocated thereto as is appropriate.

In the description to follow, unless a particular distinction is made between an outer periphery general box Ggo and an inner periphery general box Ggi, the notation of general box Gg will be used.

A jackpot challenge box Gjpc can transition to another jackpot drawing game. In this same drawing, the first jackpot challenge box Gjpc−1 and the second jackpot challenge box Gjpc−2 are disposed at positions separated on the periphery in which the inner peripheral area Arin is formed. The first jackpot challenge box Gjpc−1 and the second jackpot challenge box Gjpc−2 are associated with different, respective, jackpot drawing games. From two other jackpot drawing games, it is possible to transition to the drawing game shown in this drawing, and another two jackpot drawing games may mutually transition to the other's drawing game. That is, the configuration is such that three jackpot drawing games can transition to the other two jackpot drawing games.

A jackpot box Gjp can obtain a reward without taking on the challenge of a secondary jackpot drawing game. In this drawing, the jackpot boxes Gjp are disposed one each at positions that are substantially symmetrical with respect to the inner peripheral area Arin as a circularly peripheral area.

The number and positional relationship of inner periphery general boxes Ggi, the jackpot challenge boxes Gjpc, and the jackpot boxes Gjp disposed in the inner peripheral area Arin may be changed as is appropriate.

One character CHR is disposed in the jackpot drawing screen. The character CHR indicates a box selected by a drawing.

In the jackpot drawing game, each of the boxes disposed in the jackpot drawing game screen is a choice that is selected by a drawing. The selection of a box by a drawing is performed using a physical ball.

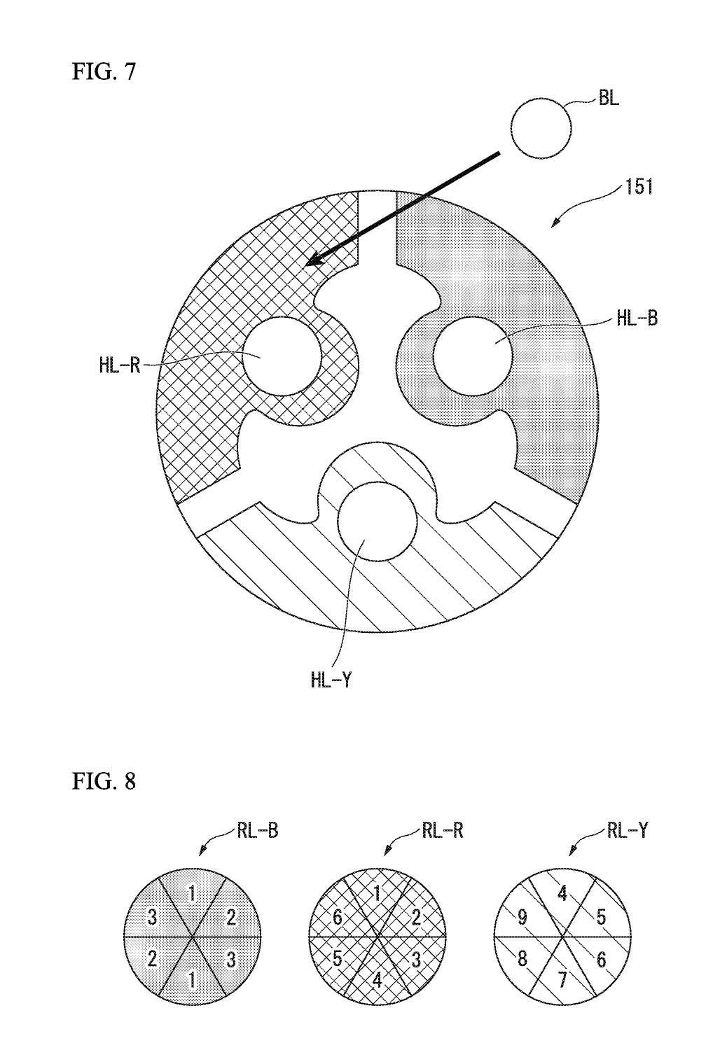

A ball drawer is provided in the station unit 11. FIG. 7 is the ball drawer 151 seen in plan view. A ball BL is inserted into the ball drawer 151 by means of a ball transport mechanism that transports the ball. Three holes HL (HL-B, HL-R, and HL-Y (examples of choices)) are disposed in the ball drawer 151. The hole HL-B corresponds to blue, the hole HL-R corresponds to red, and the hole HL-Y corresponds to yellow. The plane in the ball drawer 151 in which the three holes HL are formed has a shape by which the probabilities of a ball dropping into each of the three holes HL are the same.

The ball drawer 151, as the first-step drawing, performs a roulette wheel selection to determine the number of boxes to advance. In the present embodiment, there are a plurality of roulette wheels, with numerals allocated thereto in different patterns. In the following, the description is of a case in which there are three roulette wheels provided.

FIG. 8 shows an example of three roulette wheel RL choices of the first-step drawing (RL-B, RL-R, and RL-Y). Of the three roulette wheels RL, the roulette wheel RL-B is the blue roulette wheel. As shown in the drawing, the roulette wheel RL-B is divided into six regions (choices), and the numerals 1, 2, 3, 1, 2, and 3 are allocated to the regions.

The roulette wheel RL-R is the red roulette wheel. As shown in the drawing, the roulette wheel RL-R is divided into six regions (choices), and the numerals 1, 2, 3, 4, 5, and 6 are allocated to the regions.

The roulette wheel RL-Y is the yellow roulette wheel. As shown in the drawing, the roulette wheel RL-Y is divided into six regions (choices), and the numerals 4, 5, 6, 7, 8, and 9 are allocated to the regions.

In this manner, each of the three roulette wheels RL has a different pattern of allocated numerals.

If a ball BL is detected as having dropped into the hole HL-B in the ball drawer 151, the game machine 10 selects the blue roulette wheel RL-B. If a ball BL is detected as having dropped into the hole HL-R in the ball drawer 151, the game machine 10 selects the red roulette wheel RL-R. If a ball BL is detected as having dropped into the hole HL-Y in the ball drawer 151, the game machine 10 selects the yellow roulette wheel RL-Y.

When the selection of the roulette wheel RL is completed as noted above, the game machine 10 causes a pointer that is fixed on the screen and an image of the roulette wheel RL of the selected color, which rotates on the screen, to be displayed by the station display device provided in the station unit 11.

Having done that, the game machine 10, as the second-step drawing, in order to select the number in the roulette wheel displayed on the station display device, inserts a physical ball BL into a drawing machine (roulette drawing machine) for a roulette drawing. The roulette drawing machine, although it is not illustrated, has a structure such that the inserted ball gradually approaches a hole and ultimately falls into the hole. At the timing of detection of the dropping of the ball in the roulette machine, the game machine 10 stops the rotation of the roulette wheel RL displayed on the station display device, and the number that the pointer is pointing at determines the drawn number.

In the jackpot drawing screen (FIG. 6), the game machine 10 changes the box in which a character CHR is positioned, so that the character CHR advances from the box in which it had been disposed by the number of roulette box positions selected by the second-step drawing.

If a character had been positioned in a box in the outer peripheral area ARout, it moves between boxes in the outer peripheral area ARout, and if it had been positioned in a box in the inner peripheral area Arin, it moves between boxes in the inner peripheral area ARin.

The box that is the new position of the character that has advanced becomes the box selected as the result of the jackpot drawing. In this manner, the drawing by the first-step drawing and second-step drawing constitute one jackpot drawing.

For example, if the box at which a character CHR is positioned is a general box Gg (an outer periphery general box Ggo or an inner periphery general box Ggi), the number of points allocated to the corresponding general box Gg are granted to the player as a reward (box reward). Specifically, a payout is made of the number of medals corresponding to the number of points. The payout of medals is performed by a medal payout machine in the center unit 12, and the paid-out medals are ejected to the medal receiving tray TRA.

In the case in which the character CHR comes to be positioned at a general box Gg, if a certain association enabling condition is satisfied, that general box Gg can be occupied as the player's own ground. That is, an association is made between the general box Gg and the player. The above-noted association enabling condition is satisfying of the two conditional elements that are the player winning the jackpot drawing causing the game machine 10 to acquire the player's ID in the current game participation, and the general box Gg at which the player's character CHR is positioned not yet being the ground of another player.

In starting playing with the game machine 10 of the present embodiment, the player may or may not cause the player's card to be read into a card reader 130, causing the game machine 10 to acquire the player's ID. That is, the game machine 10 of the present embodiment, for example, can be played even by a player who does not have a player card. However, as established by the association enabling condition, the association between a general box Gg and a player is not made unless the game machine 10 has acquired the player's ID. That is, the occupation of a general box Gg as ground is an authority that is restricted to a player who has a player card.

Each time a jackpot drawing is performed, if the character CHR is positioned at a general box Gg and also the association enabling condition is satisfied, the player occupies that general box Gg as his or her ground. In this case, the number of general boxes Gg that can be occupied by one player is not limited, one player being able to occupy a plurality of general boxes Gg as his or her ground.

A mark MK that indicates that a general box Gg is already occupied by a player as his or her own ground is granted to that box, which is displayed showing the player name. In this drawing, the mark MK is imparted to, and the name of Player A is displayed at, two general boxes Gg.

A general box Gg occupied as ground by another player is not given a mark MK, and is displayed with the player name of that other player. In this drawing, one inner periphery general box Ggi is shown with the player name Player B, which is another player.

By viewing this type of display, a player can distinguish between general boxes Gg that the player occupies as his or her own ground, general boxes Gg that are occupied by another player, and general boxes Gg that are not occupied by any player.

If, as a result of a jackpot drawing, the character CHR is positioned in a general box Gg already occupied by another player, the following reward is granted. First, the receiving player in the jackpot drawing is granted a box reward in accordance with the number of points allocated to the general box Gg in which the character CHR is positioned. The other player who occupies the general box Gg in which the character CHR is positioned is also granted an occupying achievement reward (an example of an association reward) in accordance with the number of points allocated to the general box Gg. The occupying achievement reward, similar to the box reward, is granted by the payout of medals to the player.

In this manner, in the present embodiment, a player who has occupied a general box Gg as ground can also receive a reward, if, as a result of a subsequent jackpot drawing by another player, a character CHR is positioned on that general box Gg of that player.

In the present embodiment, the state in which a general box Gg is occupied as ground continues until any player obtains a jackpot reward. The jackpot reward is determined by the progressive value accumulated by bets and, if any player is granted the jackpot reward, the progressive value is reset to the initial value.

The game machine 10, in addition to granting a jackpot reward to any player and resetting the progressive value to the initial value, releases the state in which the general box Gg is occupied as ground. That is, the association between the general box Gg and the player is broken.

As a result of a jackpot drawing, if a character CHR is positioned in a warp box Gw in the outer peripheral area ARout, at the time of the next jackpot drawing, the character CHR can be made to advance after having been moved to an inner periphery general box Ggi. An inner periphery general box Ggi has a larger number of points than an outer periphery general box Ggo, and the inner periphery general boxes Ggi include jackpot challenge boxes Gjpc and jackpot boxes Gjp. For that reason, when a character CHR is positioned in the outer peripheral area ARout, the player can receive a jackpot drawing with the desire that the character CHR will be positioned just at a warp box Gw.

As a result of a jackpot drawing, if the character CHR is positioned at either of two jackpot challenge boxes Gjpc in the inner peripheral area Arin, a transition is made to another jackpot drawing game, as described above. Even if the jackpot is won as a result of the other jackpot drawing game, the player is granted a jackpot reward in accordance with the progressive value. In this case, the progressive value of each of the jackpot drawing games is accumulated independently, and even if the progressive value of one jackpot drawing game is reset to the initial value, the progressive value of the other jackpot drawing game is maintained.

As a result of a jackpot drawing, if a character CHR is positioned at either of two jackpot boxes Gjp in the inner peripheral area Arin, the jackpot reward is obtained by the player.

As described above, if a character CHR is positioned in a jackpot box Gjp and the player is granted a jackpot reward, the progressive value corresponding to that jackpot is reset to the initial value. In addition to the progressive value being reset to the initial value, the state of general boxes Gg that had been occupied as ground is cleared.

In response to the issue of a trigger for one jackpot drawing, the jackpot drawing, which is a combination of the first-step drawing and the second-step drawing, is performed an established number of times. If a jackpot is won before the jackpot drawing is made the established number of times, the jackpot drawing ends at the time when the jackpot is won. However, if the jackpot is not won even after making the jackpot drawing the established number of times, the jackpot drawing is ended at that point, and the progressive value is carried over until the next jackpot drawing is initiated.

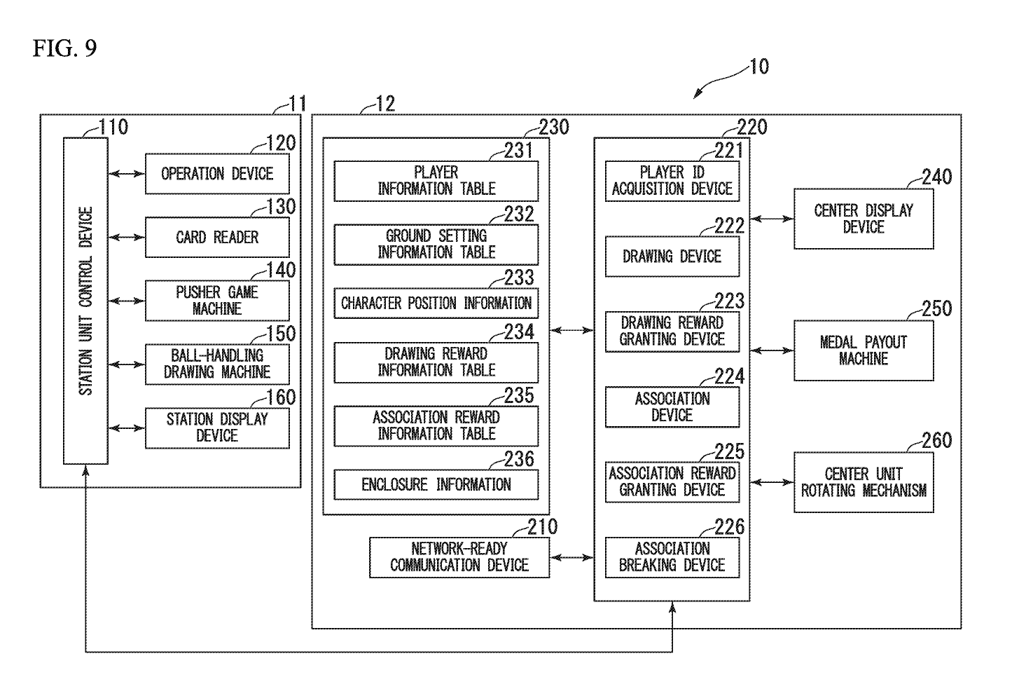

FIG. 9 shows an example of the configuration of the game machine 10. As described above, the game machine 10 has a station unit 11 and a center unit 12.

The station unit 11 has a station unit control device 110, an operation device 120, a card reader 130, a pusher game machine 140, a ball-handling drawing machine 150, and a station display device 160.

The station unit control device 110 executes various control related to the station unit 1. The functionality of the station unit control device 110 may be implemented by a CPU provided in the station unit control device 110 executing a program.

The operation device 120 indicates together various operators provided in the station unit 11. The above-described medal insertion switch 121, insertion direction change lever 122, and medal return button and the like are included in the operation device 120.

The card reader reads data from an RFID (radio frequency identifier) tag by communicating with the RIFD tag of a card, by either a contact or non-contact mode. In the present embodiment, the card read by the card reader 130 is a player card held by a player, in which a player ID (an example of player identification information) is stored. That is, the game machine 10 can acquire the player ID by reading the player card using the card reader 130.

The player card is, for example, provided to the player at a store in which the game machine 10 is installed.

In playing a game run using the game machine 10, a player causes the player ID stored in the player card to be read into the game machine 10, thereby enabling the player's game playing history to be saved in a center server.

The player may, for example, by operating the operation device 120, input a character string indicating the player ID written on the player card, so that the game machine 10 acquires the input character string as the player ID.

The pusher game machine 140, as described above, is a part of the game machine 10 constituted to have a mechanism corresponding to the pusher game.

The ball-handling drawing machine 150 includes the above-described ball drawer 151 and roulette drawing machine and the like.

The station display device 160 is provided in correspondence to each station.

The station display device 160 displays a game screen and the like as is appropriate to the progress of a game. As described above, in a jackpot drawing game the roulette wheel TL is displayed on the station display device 160.

The center unit 12 has a network-ready communication device 210, a center unit control device 220, a storage 230, a center display device 240, a medal payout machine 250, and a center unit rotating mechanism 260.

The network-ready communication device 210 communicates with the center server 30 via a network NW (FIG. 1).

The center unit control device 220 executes various control related to the center unit 12. The functionality as the center unit control device 220 may be implemented by a CPU provided in the center unit 12 executing a program.

The center unit control device 220 has a player ID acquisition device 221, a drawing device 222, a drawing reward granting device 223, an association device 224, an association reward granting device 225, and an association breaking device 226.

The player ID acquisition device 221 acquires the player ID. When the player ID is read from a player card by the card reader 130 of the game machine 10 as described above, the read player ID is transmitted to the center unit control device 220 by the station unit control device 110. In the center unit control device 220, the player ID acquisition device 221 acquires the received player ID.

The drawing device 222 selects a choice by drawing from two or more choices for one or more players. The choices include various boxes disposed on the jackpot drawing screen (FIG. 6) displayed on the center display device 240 in the jackpot drawing game.

In making a selection by a drawing, as the first-step drawing, the drawing device 222 controls the ball-handling drawing machine 150 so as to, as described above, insert a ball BL into the ball drawer 151. The drawing device 222 selects a roulette wheel RL in accordance to the detection of the dropping of the ball BL into one of the holes HL.

Until the roulette wheel RL is determined, for example, the drawing device 222, in concert with the station unit control device 110, makes a presentation that selects three roulette wheels RL on the station display device 160.

When the roulette wheel RL is determined, as the second-step drawing, the drawing device 222, in concert with the station unit control device 110, causes a pointer that is fixed on the screen and the selected roulette wheel RL, which rotates on the screen, to be displayed on the station display device 160. The drawing device 222 controls the ball-handling drawing machine 150 to insert a ball into the drawing machine. The drawing device 222 stops the roulette wheel RL displayed on the station display device 160 at the timing of detecting the dropping of the ball into a hole of the roulette drawing machine and, based on the region to which the pointer points, selects one of the numbers from among the numbers allocated to the roulette wheel RL that was selected.

The drawing device 222 causes the character in the jackpot drawing screen to advance by the number of boxes that was the selected number. In this manner, the drawing device 222 makes a drawing of boxes that are the selection choices.

The drawing reward granting device 223, based on the box selected by the drawing device 222, grants a drawing reward to the player. That is, as a result of the jackpot drawing, there a case in which the character CHR is positioned in a general box Gg. In that case, the drawing reward granting device 223 grants to the player as a drawing reward a box reward in accordance with the number of points that were allocated to the general box Gg at which the character CHR was positioned.

As a result of a jackpot drawing, in accordance with the character CHR being positioned at a jackpot challenge box Gjpc, another jackpot drawing game is run.

There is a case in which, in accordance with the character CHR being position at a jackpot box Gjp, the jackpot reward is obtained. In this case, the drawing reward granting device 223 grants to the player as a drawing reward a jackpot reward in accordance with the progressive value.

The association device 224 associates the box selected by the drawing device 222 with the player. Specifically, if the character CHR is positioned at a general box Gg in accordance to the drawing result, if the above-described association enabling condition is satisfied, the association device 224 makes an association between the general box Gg and the player. In a jackpot drawing game, by this type of association a general box Gg is set as ground occupied by the player.

If a choice is selected by the drawing device 222 after an association is made by the association device 224, the association reward granting device 225 grants an association reward to the player. That is, if as a result of a jackpot drawing by a player the character is positions on a general box Gg that had already been occupied by another player, the association reward granting device 225 grants an occupying achievement reward to the player who is the occupier of the ground. The occupying achievement reward, as described above, has a value in accordance with the number of points allocated to a general box Gg that is set as ground.

The occupying achievement reward in the present embodiment is stored into the center server 30 as information so that granting is done in the future, even if the grantee player is not playing the game machine 10 at the time granting is determined. When this is done, the association reward granting device 225 notifies the center server 30 of association reward information that includes the player ID of the grantee player and the value of the occupying achievement reward. The center server 30 stores the association reward information. Subsequently, when the player plays using the game machine 10, an occupying achievement reward indicated by the association reward information stored in the center server 30 is granted to the player by addition of credit or as a medal payout. In this manner, the occupying achievement reward can be properly granted even if the grantee player is not playing a game.

The association breaking device 226, in response to the satisfying of a prescribed breaking condition, breaks the association that had been made by the association device 224. Specifically, as a result of a jackpot drawing, by the jackpot reward (an example of a variable reward) being granted in accordance with the progressive value corresponding to the jackpot, the progressive value is returned to the initial value, accompanied by the jackpot reward in accordance with the progressive value being returned to the initial value. When the jackpot reward returns to the initial value, the association breaking device 226 breaks the association. The association breaking device 226 in the present embodiment, as described above, breaks all the associations between general boxes Gg and players.

The storage 230 stores various information used by the center unit control device 220. As shown in the same drawing, the storage 230 stores a player information table 231, a ground setting information stable 232, character position information 233, a drawing reward information table 234, an association reward information table 235, and enclosure information 236.

The player information table 231 has records of player information corresponding to each player playing the game machine 10. One record of player information in the player information table 231 includes fields for the player ID, the player name, and the station unit ID indicating the station unit 11 that the player is playing. The player name information can be acquired, for example, from a player information table registered in the center server 30.

The ground setting information table 232 has records that are information indicating the setting states as ground for general boxes Gg, with the ground setting information with respect to each general box Gg being a record. One record of ground setting information includes fields for a box ID identifying the general box Gg, and the player ID indicating the player occupying the corresponding general box Gg.

The character position information 233 indicates the position of the character CHR in the jackpot drawing screen. The character position information 233 includes a box ID that indicates the box in which the character CHR is positioned.

The drawing reward information table 234 has records that are drawing reward information for each drawing reward (box rewards and jackpot rewards) granted to a player playing the game machine 10. One record of the drawing reward information table 234 includes fields for the player ID, the date and time of establishment of the reward, the type of reward, and the reward value. The reward type indicates, for example, whether the drawing reward is a box reward or a jackpot reward.

The above-noted box reward and jackpot reward are made by a payout of medals, but a drawing reward, for example, can also be made by granting items or special privileges in a game, in which case there is also reflection in the reward type of whether the reward is by a medal payout or by the granting of an item or special privilege. If an item or a special privilege is granted, the reward value field holds information that identifies the item or the special privilege.

The association reward information table 235 has records that are association reward information indicating the granting state of an association reward (an example of association reward information) regarding a player playing the game machine 10. One record in the association reward information table 235 includes fields for the player ID, the date and time of establishment of the reward, the reward type, and the reward value. With regard to this reward type as well, for example, this can reflect the reward being the payout of medals or the granting of an item or special privilege.

The enclosure information 236 indicates the game machine 10 that is the local machine. Specifically, the enclosure information 236 is the enclosure ID as an identifier uniquely indicating the game machine 10.

The player information stored in the player information table 231, the ground setting information stored in the ground setting information table 232, the drawing reward information stored in the drawing reward information table 234, the association reward information stored in the association reward information table 235, and the enclosure information 236 are each transmitted to the center server 30 at a prescribed timing. The center server 30 stores the various information transmitted from each of the game machines 10 subordinate to it.

The center display device 240, as shown in FIG. 2, is disposed in the center unit 12.

The medal payout machine 250 is the part at which, in accordance with the reward such as the box reward, the occupying achievement reward, and the jackpot reward, a number of medals according to the granted reward are paid out to the player, under the control of the center unit control device 220.

The center unit rotating mechanism 260 is the location at which a mechanism for rotating the center unit 12 is provided. The center unit control device 220 controls the rotation of the center unit rotating mechanism 260.

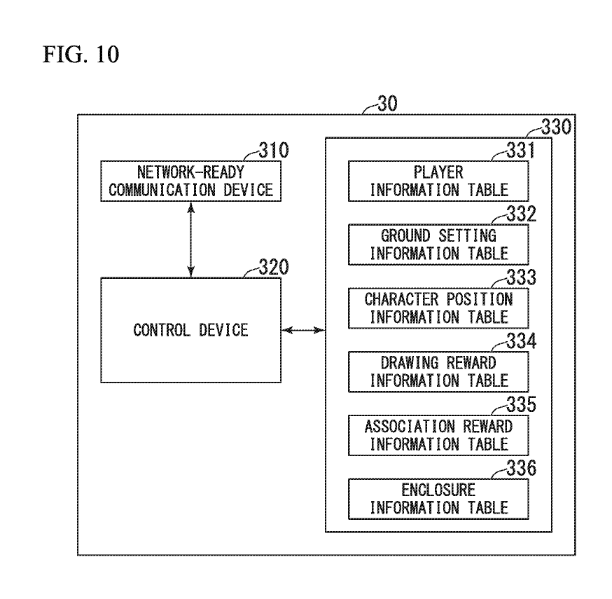

FIG. 10 shows an example of the configuration of the center server 30, in which the center server 30 shown has a network-ready communication device 310, a control device 320, and a storage 330.

The network-ready communication device 310 communicates with the game machine 10 via a network NW.

The control device 320 executes various control in the center server 30. The function as the control device 230 is implemented by a CPU provided in the center server 30 executing a program.

The storage 330 stores various types of information used by the control device 320. The storage 330 shown in the drawing has a player information table 331, a ground setting information table 332, a character position information table 333, a drawing reward information table 334, an association reward information table 335, and an enclosure information table 336.

The player information table 331 is a database in a table format of the player information transmitted from each game machine 10.

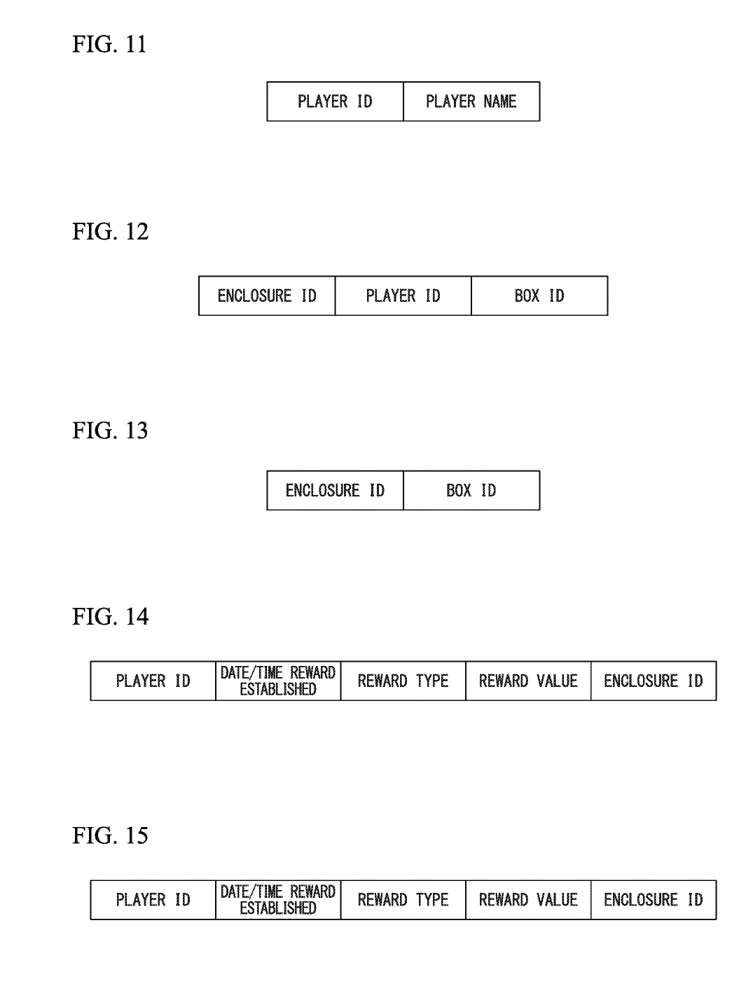

FIG. 11 shows an example of the structure of the player information as one record in the player information table 331. As shown in this drawing, the player information has fields for the player ID and the player name.

The ground setting information table 332 is a database in a table format of the ground setting information transmitted from each game machine 10.

FIG. 12 shows an example of the structure of the ground setting information as one record in the ground setting information table 332. As shown in this drawing, the ground setting information has a structure in which the fields for the player ID and the box name are associated with a field for the enclosure ID. That is, the ground setting information in the ground setting information table 332 has a structure in which the enclosure ID that indicates the transmitting game machine 10 is further associated with the player ID and box ID transmitted as ground setting information from the game machine 10.

The character position information table 333 is a database in a table format of the character position information transmitted form each game machine 10.

FIG. 13 shows an example of the structure of the character position information as one record in the character position information table 333. As shown in this drawing, the character position information has a structure in which the box ID field is associated with the enclosure ID field. That is, the character position information in the character position information table 333 has a structure in which the box ID transmitted as the character position information from the game machine 10 is further associated with the enclosure ID indicating the game machine 10 originating the transmission.

The drawing reward information table 334 is a database in a table format of drawing reward information transmitted from each game machine 10.

FIG. 14 shows an example of the structure of the drawing reward information as one record in the drawing reward information table 334. As shown in this drawing, the drawing reward information has fields for the player ID, the date and time of establishment of the reward, the reward type, the reward value, and the enclosure ID. That is, the drawing reward information in the drawing reward information table 334 has a structure in which the player ID, the date and time the reward is established, the reward type, and the reward value transmitted as drawing reward information from the game machine 10 are further associated with the enclosure ID identifying the game machine 10 that originated the transmission.

The association reward information table 335 is a database in a table format of association reward information transmitted from each game machine 10.

FIG. 15 shows an example of the structure of the association reward information as one record in the association reward information table 335. As shown in this drawing, the association reward information has fields for the player ID, the date and time the reward is established, the reward type, the reward value, and the enclosure ID. That is, the association reward information has a structure in which the player ID, the date and time the reward is established, the reward type, and the reward value are further associated with the enclosure ID indicating the game machine 10 that originated the transmission.

The enclosure information table 336 is a database in a table format of enclosure information transmitted from each game machine 10. As described above, the enclosure information includes an enclosure ID that uniquely identifies the game machine 10.

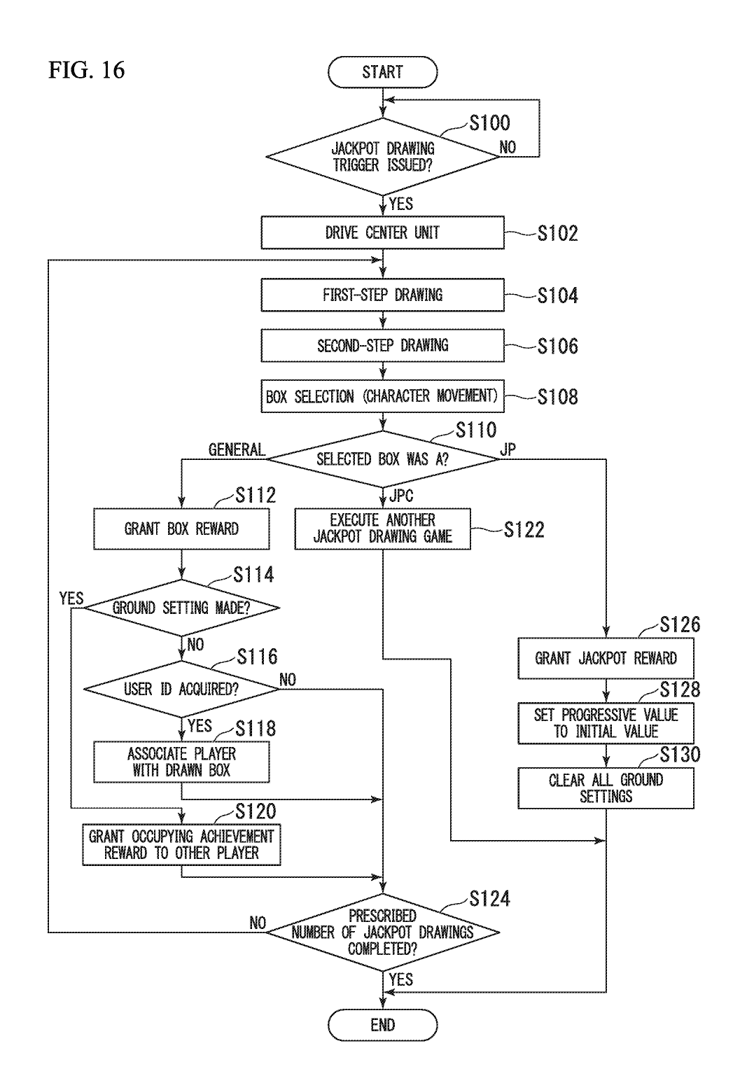

Referring to the flowchart of FIG. 16, an example of the processing procedure related to a jackpot drawing executed by the game machine 10 will be described.

In the game machine 10, the station unit control device 110 waits for a jackpot drawing trigger in its own station unit 11 (NO at step S100).

When a jackpot drawing trigger is issued (YES at step S100), notification is made to that effect to the center unit control device 220. Upon receiving the notification of the issuance of the jackpot drawing trigger, the center unit control device 220, for example, drives the center unit rotating mechanism 260 so as to rotate the center unit 12 so that the center display device 240 faces the station unit 11 at which the jackpot drawing trigger was issued (step S102). When this is done, the drawing device 222 of the center unit control device 220 causes the jackpot drawing screen to be displayed on the center display device 240.

Next, the drawing device 222 causes the target station unit 11 to executed a first-step drawing (step S104). To do this, the drawing device 222 requests that the station unit control device 110 of the target station unit 11 execute the first-step drawing. The station unit control device 110, in response to the first-step drawing execution request, controls the ball transport mechanism of the ball-handling drawing machine 150 so as to insert a ball into the ball drawer 151.

When the dropping of a ball into any one of the three holes in the ball drawer 151 is detected, the station unit control device 110 notifies the center unit control device 220 of the first-step drawing result of which of the three holes was selected.

In the center unit control device 220, the drawing device 222 selects one of the three roulette wheels RL, based on the notified result of the first-step drawing. Having done that, the drawing device 222 causes the station unit 11 that is the target for the second-step drawing to execute the second-step drawing (step S106). To do this, the drawing device 222 requests the station unit control device 110 of the target station unit 11 to execute the second-step drawing.

In response to the second-step drawing execution request, the station unit control device 110 controls the ball transport mechanism of the ball-handling drawing machine 150 so as to insert a ball into the roulette drawing machine.

At the timing at which the insertion of the ball into the roulette drawing machine is detected, the rotation of the roulette wheel on the station display device 160 is stopped, thereby selecting one of the numbers allocated to the roulette wheel.

The drawing device 222 selects the box in accordance with the number selected from the roulette wheel RL (step S108). When doing this, the drawing device 222 moves the character CHR disposed on the jackpot drawing screen displayed on the center display device 240 to the position of the selected box.

Next, the drawing device 222 determines whether the box selected at step S108 is a general box Gg (outer periphery box Ggo or inner periphery box Ggi), a jackpot challenge box Gjpc, or a jackpot box Gjp (step S110).

If the determination is that the selected box is a general box Gg (General at step S110), the drawing reward granting device 223 grants a box reward to the player of the target station unit 11 (step S112). As the processing of step S112, the drawing reward granting device 223 registers drawing reward information with contents that reflect the granting of the current reward into the drawing reward information table 234 of the player of the target station unit 11.

Next, the association device 224 determines whether or not the selected general box had already been occupied as ground by another player (step S114). In making the determination at step S114, the association device 224 references the ground setting information table 232.

If the box had not already been set as the ground for another player (NO at step S114), the association device 224 a further determination is made as to whether or not the player ID of the player of the target station unit 11 has been acquired (step S116). In starting the playing of the game machine 10 of the present embodiment, if the player of the target station unit 11 has the card reader 130 read a player card, the player ID is registered in the player information table 231, in which case the player ID will have already been acquired.

If the player ID had already been acquired (YES at step S116), the association device 224 stores into the ground setting information table 232 ground setting information in which the player of the target station unit 11 is associated with the selected general box (step S118). By the processing of step S118, in the jackpot drawing screen, the general box associated at this time is displayed with the mark MK and the player's name added thereto.

If, however, the player ID had not already been acquired (NO at step S116), the processing of step S118 is skipped. That is, the selected box is not set as the ground of the player of the target station unit 11.

If the selected general box Gg had already been set as the ground for another player (YES at step S114), the association reward granting device 225 grants an occupying achievement reward to the other player that occupies the general box as the player's ground (step S120). As the processing of step S120, the association reward granting device 225 registers into the association reward information table 235 association reward information with contents that reflect the granting of the current occupying achievement reward.

If the selected box was a jackpot challenge box Gjpc (JPC at step S110), the drawing device 222 performs control so as to execute another jackpot drawing game in accordance with the selected jackpot challenge box Gjpc (step S122).

If the player ID has not been acquired (NO at step S116), or if processing had been ended at step S118 or step S120, the drawing device 222 performs the following determination. Specifically, the drawing device 222 determines whether or not a prescribed number of jackpot drawings have been completed (step S124).

If the prescribed number of jackpot drawings have not been completed (NO at step S124), return is made to step S104), thereby restarting the next jackpot drawing.

If, however, the completion of the current jackpot drawing completes the prescribed number of jackpot drawings (YES at step S124), the jackpot drawings are ended.

If the selected box was a jackpot box (JP at step S110), the following processing is executed.

Specifically, the drawing reward granting device 223 grants a jackpot reward to the player of the target station unit 11 (step S126). As the processing of step S126, the drawing reward granting device 223 registers into the drawing reward information table 234 drawing reward information with contents that reflect the granting of the current jackpot reward.

Accompanying the granting of the jackpot reward, the drawing reward granting device 223 sets the progressive value corresponding to the jackpot, which had been thus far accumulating, to the initial value (step S128). As described above, by setting the progressive value to the initial value, the jackpot reward value is also set to the initial value.

As noted above, accompanying the granting of a jackpot reward and the setting of the progressive value to the initial value, the condition for breaking the association between the general box and the player has been satisfied. Given this, the association breaking device 226 breaks all the associations between the general and players that have been made up until then (step S130). To do that, the association breaking device 226 clears (deletes) or invalidates all of the ground setting information stored in the ground setting information table 232.

### Recap of the Embodiment

(1) As described above, the game machine 10 in the present embodiment (an example of a drawing game system) has a drawing device 222, a drawing reward granting device 223, an association device 224, and an association reward granting device 225.

The drawing device 222 selects a box by drawing from among two or more boxes (examples of choices) for one or more players. The drawing reward granting device 223 grants a box reward or a jackpot reward (an example of a drawing reward) to a player, based on the choice selected by the drawing device 222. The association device 224 associates the box (general box) selected by the drawing device 222 with a player. If a box had been selected by the drawing device after an association had been made by the association device 224, the association reward granting device 225 grants to the player an occupying achievement reward (an example of an association reward).

According to the above-noted configuration, in the jackpot drawing, a box reward is obtained in accordance with the box selection, and there is the additional game element that, if a box is selected after it is occupied as ground an occupying achievement reward is obtained. Doing this, because there remains the possibility of getting a large reward even if the progressive value is returned to the initial value by the obtaining of the jackpot reward, motivation can be given to a player to participate in the drawing game later.

(2) In the game machine 10 of the present embodiment, if a prescribed association enabling condition has been satisfied, the association device 224 associates the box selected by the drawing device 222 with the player.

According to the above-noted configuration, even if, as the result of a jackpot drawing it was not possible to obtain a jackpot challenge or jackpot, if the association enabling condition is satisfied, the player can occupy the box as the player's ground. By doing this, even a player who was not able to obtain a jackpot challenge or a jackpot can continue the game without losing interest in the game.

(3) In the game machine 10 of the present embodiment, the drawing device 222 can make a drawing to select choices for each of two or more players, and the association device 224 can make as at least one association enabling condition that there are no more than a prescribed number of players already associated with the box selected by the drawing device 222.

According to the above-noted configuration, because a jackpot drawing for a plurality of players is made possible, there is a possibility that the same box is selected for a plurality of players. Given this, if the number of players already associated with a selected box is at least a prescribed number, by not performing associations with a subsequent player and that box, there will not be an unlimited number of players associated with the same box, thereby enabling the maintenance of balance in the game.

(4) A game machine 10 according to the present embodiment further has a player ID acquisition device 221 (an example of an identification information acquisition device) that acquires the player ID (an example of player identification information), and the association device 224 makes as at least one association enabling condition the acquisition of the player ID by the player ID acquisition device 221.

According to the above-noted configuration, for example, by a player holder a player card by performing a player registration, it is possible to restrict the occupation of a box as a player's ground to a player who can have the game machine 10 read the player ID.

(5) A game machine 10 of the present embodiment further has an association breaking device 226 that, in response to satisfying a prescribed breaking condition, breaks all or a part of the associations made by the association device 224.

According to the above-noted configuration, by appropriately setting the breaking condition, the association between a player and a box can be broken at an appropriate opportunity. Doing this, a jackpot drawing can be made while maintaining game balance.

(6) In a game machine 10 of the present embodiment, in response to the breaking condition of a specific box being selected by the drawing device 222, the association breaking device 226 breaks a part or all of the associations made by the association device 224.

According to the above-noted configuration, the association with a player is cleared by the selection of a specific box. Doing this, by selecting an appropriate box as the specific box, the state in which a player occupies a box as the player's ground can be cleared at a more-appropriate opportunity.

(7) In a game machine 10 of the present embodiment, at least some of the boxes correspond to a jackpot reward (an example of a variable reward) determined in accordance with the progressive value. If a box (jackpot box) corresponding to a progressive value is selected by the drawing device 222, the drawing reward granting device 223 grants to the player a jackpot reward and simultaneously sets the progressive value (that is, the jackpot reward) to a prescribed initial value. The association breaking device 226 makes at least one breaking condition the return of the jackpot reward to the initial value.

According to the above-noted configuration, if the jackpot reward is granted and the progressive value returned to the initial value in response to one player obtaining a jackpot, the state of occupation of the box by the player as ground can be cleared. The state of the progressive value being returned to the initial value is the state in which a large reward cannot be obtained by a jackpot. From this state, therefore if the state in which the occupation of a box as ground by a player is cleared, because the difference in relative strengths between players is eased, players can be motivated thereafter to actively participate in jackpot drawings.

Modified examples of the present embodiment will now be described.

### First Modified Example

In the above-noted embodiment, as an association enabling condition for associating a general box with a player (the player occupying the general box as ground), is the satisfying of the two conditional elements that are the player winning the jackpot drawing causing the game machine 10 to acquire the player's ID in the current game participation, and the general box Gg at which the player's character CHR is positioned not yet being the ground of another player.

The association enabling condition in the present embodiment is not restricted to that noted above. For example, being within a pre-established period of time may be made one conditional element of the association enabling condition.

As a specific example, if a certain amount of time has not yet elapsed from the obtaining of the jackpot and resetting of the progressive value to the initial value, the association device 224 makes an association between the general box and the player, but does not make the association if the certain amount of time has elapsed.

Alternatively, if a certain amount of time has not yet elapsed from the a player making a progressive value, the association device 224 makes an association between the general box and the player, but does not make the association if the certain amount of time has elapsed.

### Second Modified Example

That the progressive value corresponding to a jackpot should be within a prescribed range may be included as one conditional element of the association enabling condition in the present embodiment. In this case, if in addition to other conditional elements in the association enabling condition, if the conditional element of the progressive value corresponding to the jackpot being within a prescribed range is satisfied, the association device 224 makes an association between the general box and the player.

### Third Modified Example

In the present embodiment, the number of general boxes associated with one player may be limited to no greater than a prescribed number. In this case, “the number of general boxes associated with a player that is the subject of association with a general box being no greater than a prescribed number” is included as one conditional element of the association enabling condition.

In this case, in addition to other conditional elements in the association enabling condition, if the conditional element of the number of general boxes associated with a player that is the subject of association with a general box being no greater than a prescribed number is satisfied, the association device 224 makes an association between the general box and the player.

### Fourth Modified Example

In the present embodiment, the number of players associated with one box may be limited to no greater than a prescribed number (if the prescribed number is one player, this would correspond to the above-noted embodiment). In this case, “the number of players that are subject to association with a general box being no greater than a prescribed number” is included as one conditional element of the association enabling condition.

In this case, in addition to other conditional elements in the association enabling condition, if the conditional element of “the number of players that are subject to association with a general box being no greater than a prescribed number” is satisfied, the association device 224 makes an association between the general box and the player.

### Fifth Modified Example

The reaching of an association enabling target for a player receiving an association to general box may be made one conditional element of the association enabling condition. For example, the placement of at least a prescribed number of medals on the playfield can be cited as an association enabling target. The getting of a specific item in the game can be cited as an association enabling target.

In this case, in addition to other conditional elements in the association enabling condition, if the conditional element of reaching the association enabling target is satisfied, the association device 224 makes an association between the general box and the player.

### Sixth Modified Example

In the above-noted embodiment, an association is made between one general box and one player. The association device 224, however, may make an association between one general box and a plurality of different players.

In this case, in granting an occupying achievement reward to a plurality of players corresponding to one general box, the association reward granting device 225, for example, may grant to each player a uniform occupying achievement reward in response to the number of points allocated to the corresponding general box.

Alternatively, the association reward granting device 225 may change the value of the occupying achievement reward to be granted to each player in accordance with the number of players. As a specific example, the association reward granting device 225 may grant to each player an occupying achievement reward in accordance with the number of points that is the number of points allocated to the corresponding general box divided uniformly by the number of players.

### Seventh Modified Example

In the above-noted embodiment, a jackpot reward is granted and, in response to satisfying a breaking condition of setting the progressive value to an initial value, the associations between a general box and players up until that point were broken.

However, the association breaking device 226 may be made to break some of the associations between a general box and players up until that point. As an example, the association breaking device 226, without breaking the association between a general box and players of a plurality of players for which the occupying achievement reward accumulated value is the smallest, breaks the association between the general box and the other remaining players.

### Eighth Modified Example

As one form of clearing a part of the associations made thus far between a general box and a player, if an association can be made, as in the above-noted third modified example, of a plurality of players with respect to one general box, the following may be done.

Specifically, the association breaking device 226 may clear associations with some of the players of the associations between one general box and a plurality of players. In this case as well, for example, the association breaking device 226 may leave the associations of players meeting a prescribed breaking immunity condition as is, and clear the association between the general box and the remaining players.

### Ninth Modified Example

In the above-noted embodiment, the breaking condition regarding the association between a general box and a player was the jackpot reward being granted and the progressive value being set to the initial value. However, a different breaking condition may be established in the present embodiment.

For example, the association breaking device 226 may clear the all or a part of the associations between a general box and players according to the satisfying of the condition of the arrival of a prescribed time. This prescribed time may be, for example, a pre-established date and time. Alternatively, the prescribed time may be the point in time at which a prescribed amount of time has elapsed from the time an association was made between the general box and a player.

### Tenth Modified Example

The association breaking device 226 of the present embodiment may clear all or a part of the associations between a general box and players, in accordance with the satisfying of a breaking condition that is the making of a prescribed number of jackpot drawings from the time of the association between the general box and a player.

### Eleventh Modified Example

The association breaking device 226 of the present embodiment may clear the association with a player for whom the occupying achievement reward total has reached a certain value, in accordance with the satisfying of the breaking condition when the total of the occupying achievement rewards granted reaches a certain value.

### Twelfth Modified Example

The value (quantity) of the occupying achievement reward in the above-noted embodiment corresponded to the number of points allocated to the general box.

Specifically, for example, corresponding to one general box associated with one player, an occupying achievement reward of a uniform value corresponding to the number of allocated points is granted each time there is selection by a jackpot drawing of another player.

In contrast to the above, for example, the association reward granting device 225, regarding one general box associated with one player, may vary the value of the occupying achievement reward granted to the one player, in accordance with the number of times of selection by a jackpot drawing of another player. Specifically, the association reward granting device 225 may reduce the value of the occupying achievement reward in a stepwise manner, each time one general box associated with one player is selected by the jackpot drawing of another player.

### Thirteenth Modified Example

In the above-noted embodiment, if a general box associated with another player is selected by a jackpot drawing for one player, a box reward and an occupying achievement reward of values in accordance with the number of points allocated to the general box were granted to each of the one player and another player. In this case, the box reward and the occupying achievement reward are the same type of reward with regard to being the same value in accordance with the same number of points, the same value being based on the same number of points. That is, the contents of the box reward and the occupying achievement reward are the same.

However, if a general box selected by a drawing by the drawing device 222 for one player had already had a player associated with it, the drawing reward granting device 223 may change the contents of the reward granted to the one player.

Specifically, in the case in which, as noted above, a general box is selected to which another player is associated, having granted the other player an occupying achievement reward in accordance with the number of points allocated to the general box, a box reward having a value different from the occupying achievement reward (for example, a value smaller than the occupying achievement reward) is granted to the one player.

Although the occupying achievement reward and the box reward in the above-noted embodiment are both granted to the players as the payout of medals, rather than a payout of medals, an item or a special privilege, for example, may be granted as the box reward granted to the one player.

### Fourteenth Modified Example

As the reverse of the thirteenth modified example, if another player is associated with a general box that was selected by a jackpot drawing for one player, the drawing reward granting device 223 may change the contents of the occupying achievement reward to be granted to the other player with respect to the box reward to be granted to the one player.

Specifically, having granted a box reward in accordance with the number of points allocated to the general box to the one player, the other player is granted as an occupying achievement reward a value that is double the box reward.

That is, according to the present modified example, a player having a general box as his or her own ground, as a result of a jackpot drawing for a player other than himself or herself, if the character CHR comes to be positioned on a general box that is his or her ground, the occupier of the ground can get an occupying achievement reward greater than the value in accordance with the number of points allocated to the general box.

### Fifteenth Modified Example

Similar to the fifth modified example, if the association of a plurality of different players is permitted with on general box, the association reward granting device 225 may be constituted as follows. Specifically, if a general box selected by a drawing device 222 for one player is already associated with a player other than the one player, the association reward granting device 225 may change the contents of the reward to be granted to the one player.

As an example, when an occupying achievement reward is to be granted corresponding to a general box with which a plurality of players are associated, for a player that who was associated afterwards, a smaller occupying achievement reward may be granted, compared to a player who was associated earlier. When this is done, the association reward granting device 225 may, for example, set priority rankings in accordance with the sequence of making associations, and determine the value of the occupying achievement rewards to be granted to each of a plurality of players by applying weighting in accordance with the priority ranking.

### Sixteenth Modified Example

In the above-noted embodiment, a jackpot drawing is made for each individual player. The drawing device 222, however, may make a jackpot drawing simultaneously for a plurality of players together, so that the plurality of players obtain the same jackpot drawing results simultaneously.

### Seventeenth Modified Example

In the above-noted embodiment, as one jackpot drawing, the two steps of the first-step drawing and the second-step drawing are made. However, there is no particular limitation regarding the number of steps of drawing that are performed in one jackpot drawing. For example, one jackpot drawing may be made by making a drawing with only one step, in which case a specific example is that one type of roulette wheel is used in making one jackpot drawing to perform a drawing.

### Eighteenth Modified Example

For example, a part of the player ID acquisition device 221, the drawing device 222, the drawing reward granting device 223, the association device 224, the association reward granting device 225, and the association breaking device 226 of the center unit control device 220 in the game machine 10 of FIG. 9 may be provided as a functional part of the control device 320 in the center server 30.

From the foregoing, the embodiments can be understood as follows. Although, as a convenience to facilitate an understanding of the present invention, reference symbols of the attached drawings are indicated in parentheses, there is no restriction to the illustrated aspects of the present invention.

A drawing game system according to an aspect of the present invention (for example the game machine 10) has a drawing device (222, S104, S106, S122) that selects a choice by a drawing from among two or more choices for one or more players, a drawing reward granting device (223, S104, S106, S122) that, based on the choice selected by the drawing device, grants to the player a drawing reward (for example, a box reward or a jackpot reward), an association device (224, S118) that makes an association between the choice selected by the drawing device and the player, and an association reward granting device (225, S120) that, if the choice was selected by drawing device was selected after an association was made after an association was made by the association device, grants an association reward to the player.

According the above-noted configuration, there is an additional game element of getting a drawing reward in accordance with the drawing result of the choice in a drawing game. Doing this, because there remains the possibility of getting a large reward even if the value of the reward to be granted to a player in accordance with winning a jackpot in the drawing game, motivation can be given to a player to participate in the drawing game later.

An aspect of the present invention is the drawing game system described in (Note 1), wherein, if a prescribed association enabling condition is satisfied, the association device associates the choice selected by the drawing device with the player.

According to the above-noted configuration, even if a jackpot drawing result is not obtained, an association between the player and the choice is enabled if the association enabling condition is satisfied. Doing this, even if a jackpot drawing result is not obtained, the game can be continued without loss of interest in the game.

An aspect of the present invention is the drawing game system described in (Note 1), wherein the drawing device can make a drawing that selects a choice for each of two or more players, the number of players already associated with the choice selected by the drawing device 222 being less than a prescribed number is made at least one association enabling condition by the association device.

According to the above-noted configuration, because the game is run for a plurality of players, there is a possibility that the same choice is selected for a plurality of players. Given this, by not making an association with subsequent players regarding a selected choice if the number of players already associated with that selected choice is at least a prescribed number, the situation in which an unlimited number of player are associated with the same choice is eliminated, and the balance of the game can be maintained.

An aspect of the present invention is the drawing game system described in either (Note 2) or (Note 3), further having an identification information acquisition device (for example, the player ID acquisition device 221) that acquires identification information of the player (for example, the player ID), wherein the association device makes the acquisition of the player identification information by the identification information acquisition device at least one of the association enabling conditions (S116).

According to the above-noted configuration, only a player who can have the drawing game system acquire the player's identifier can occupy a box as his or her own ground.

An aspect of the present invention is the drawing game system described in any one of (Note 1) to (Note 4), further having an association breaking device (226, S130) that, in accordance with the satisfying of a prescribed breaking condition, can break all or a part of the associations between players and a choice.

In accordance with the above-noted configuration, by appropriately setting the breaking condition, the association between a player and a choice can be broken at an appropriate opportunity. Doing this enables a drawing game to run while maintaining the game balance.

An aspect of the present invention is the drawing game system described in (Note 5), wherein the association breaking device breaks all or a part of the associations made by the association device, in accordance with the satisfying of a breaking condition that is the selection of a specific choice by the drawing device.

According to the above-noted configuration, in accordance with the selection of a specific choice as a result of a drawing game, the association between the choice and the player is broken. Doing this, by selecting an appropriate choice as the specific choice, the state in which a player occupies the choice as the player's ground can be cleared at a more appropriate opportunity.

An aspect of the present invention is the drawing game system described in (Note 6), wherein at least a part of the choices correspond to a variable reward (for example, a jackpot reward) and, if a choice corresponding to the variable reward is selected by the drawing device, the drawing reward granting device grants the variable reward to the player and simultaneously returns the value of the variable reward to a prescribed initial value, and the association breaking device makes the return of the value of the variable reward to the initial value at least one of the breaking conditions.

In this case, the above-noted variable reward is a reward based on the progressive value that is progressively accumulated by players betting. The variable reward may be a reward based on the progressive value that is increased in accordance with the number of times a drawing is made. The variable reward may be a reward based on the amount of elapsed time. The variable reward may be a reward based on the progressive value that is increased based on the acquisition of an item or the like.

According to the above-noted configuration, if any of the players gets a jackpot and is granted a jackpot reward and the progressive value is returned to the initial value, the state in which the player occupies a box as his or her ground can be cleared. The state in which the progressive value has been returned to the initial value is a state in which it is not possible to get a large reward by a jackpot. From this state, therefore, if the state in which a player occupies a box as the player's ground is cleared, because the difference in relative strengths between players is eased, players can be motivated thereafter to actively participate in jackpot drawings.

Each element or device for the game apparatus described above can be implemented by hardware with or without software. In some cases, the game apparatus may be implemented by one or more hardware processors and one or more software components wherein the one or more software components are to be executed by the one or more hardware processors to implement each element or device for the game apparatus. In some other cases, the game apparatus may be implemented by a system of circuits or circuitry configured to perform each operation of each element or device for the game apparatus.

The systems and methods in the above-described embodiments may be deployed in part or in whole through a machine or circuitry that executes computer software, software components, program codes, and/or instructions on one or more processors. The one or more processors may be part of a general-purpose computer, a server, a cloud server, a client, network infrastructure, mobile computing platform, stationary computing platform, or other computing platform. One or more processors may be any kind of computational or processing device or devices which are capable of executing program instructions, codes, binary instructions and the like. The one or more processors may be or include a signal processor, digital processor, embedded processor, microprocessor or any variants such as a co-processor, for example, math co-processor, graphic co-processor, communication co-processor and the like that may directly or indirectly facilitate execution of program codes or program instructions stored thereon. In addition, the one or more processors may enable execution of multiple programs, threads, and codes. The threads may be executed simultaneously to enhance the performance of the one or more processors and to facilitate simultaneous operations of the application. Program codes, program instructions and the like described herein may be implemented in one or more threads. The one or more processors may include memory that stores codes, instructions and programs as described herein. The processor may access a non-transitory processor-readable storage medium through an interface that may store codes, instructions and programs as described herein and elsewhere. The non-transitory processor-readable storage medium associated with the processor for storing programs, codes, program instructions or other type of instructions capable of being executed by the computing or processing device may include but may not be limited to one or more of a memory, hard disk, flash drive, RAM, ROM, CD-ROM, DVD, cache and the like.

A processor may include one or more cores that may enhance speed and performance of a multiprocessor. In some embodiments, the process may be a dual core processor, quad core processors, other chip-level multiprocessor and the like that combine two or more independent cores.

The methods and systems described herein may be deployed in part or in whole through a machine that executes computer software on a server, client, firewall, gateway, hub, router, or other such computer and/or networking hardware.

The software program may be associated with one or more client that may include a file client, print client, domain client, internet client, intranet client and other variants such as secondary client, host client, distributed client and the like. The client may include one or more of memories, processors, computer readable media, storage media, physical and virtual ports, communication devices, and interfaces capable of accessing other clients, servers, machines, and devices through a wired or a wireless medium, and the like. The programs or codes as described herein may be executed by the client. In addition, other devices required for execution of methods as described in this application may be considered as a part of the infrastructure associated with the client. The client may provide an interface to other devices including servers, other clients, printers, database servers, print servers, file servers, communication servers, distributed servers and the like. This coupling and/or connection may facilitate remote execution of program across the network. The networking of some or all of these devices may facilitate parallel processing of a program or method at one or more location. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The software program may be associated with one or more servers that may include a file server, print server, domain server, internet server, intranet server and other variants such as secondary server, host server, distributed server and the like. The server may include one or more of memories, processors, computer readable media, storage media, physical and virtual ports, communication devices, and interfaces capable of accessing other servers, clients, machines, and devices through a wired or a wireless medium, and the like. The methods, programs or codes as described herein may be executed by the server. In addition, other devices required for execution of methods as described in this application may be considered as a part of the infrastructure associated with the server. The server may provide an interface to other devices including clients, other servers, printers, database servers, print servers, file servers, communication servers, distributed servers, social networks, and the like. This coupling and/or connection may facilitate remote execution of program across the network. The networking of some or all of these devices may facilitate parallel processing of a program or method at one or more locations. Any of the devices attached to the server through an interface may include at least one storage medium capable of storing programs, codes and/or instructions. A central repository may provide program instructions to be executed on different devices. In this implementation, the remote repository may act as a storage medium for program codes, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing devices associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory, for example, USB sticks or keys, floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods, devices, apparatus, and systems described herein may transform physical and/or or intangible items from one state to another. The methods and systems described herein may also transform data representing physical and/or intangible items from one state to another.

The modules, engines, components, and elements described herein, including in flow charts and block diagrams throughout the figures, imply logical boundaries between the modules, engines, components, and elements. However, according to software or hardware engineering practices, the modules, engines, components, and elements and the functions thereof may be implemented on one or more processors, computers, machines through computer executable media, which are capable of executing program instructions stored thereon as a monolithic software structure, as standalone software modules, or as modules that employ external routines, codes, services, or any combination of these, and all such implementations may be within the scope of the present disclosure. Examples of such machines may include, but is not limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers, processor-embedded eyewear and the like. Furthermore, the modules, engines, components, and elements in the flow chart and block diagrams or any other logical component may be implemented on one or more machines, computers or processors capable of executing program instructions. Whereas the foregoing descriptions and drawings to which the descriptions have been referred set forth some functional aspects of the disclosed systems, no particular arrangement of software for implementing these functional aspects should be inferred from these descriptions unless explicitly stated or otherwise clear from the context. It will also be appreciated that the various steps identified and described above may be varied, and that the order of steps may be adapted to particular applications of the techniques disclosed herein. All such variations and modifications are intended to fall within the scope of this disclosure. The descriptions of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While certain embodiments of the present inventions have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A drawing game system comprising:
a drawing device configured to draw for one or more players a choice from among two or more choices;
a drawing reward granting device configured to grant the one or more players with a drawing reward, based at least in part on the choice drawn by the drawing device;
an association device configured to associate the one or more players with the choice drawn by the drawing device; and
an association reward granting device configured to grant the one or more players with an association reward, in case that after the choice was associated by the association device, the choice has been drawn by the drawing device.

2. The drawing game system according to claim 1,
wherein the association device is configured to associate the one or more players with the choice drawn by the drawing device in case that a predefined association enabling condition is satisfied.

3. The drawing game system according to claim 1,
wherein the drawing device is configured to draw a respective choice for each of players,
wherein the predefined association enabling condition includes at least a condition that the number of players that are associated with the choice or choices drawn by the drawing device is less than a predefined threshold.

4. The drawing game system according to claim 2, further comprising:
an identification acquisition device configured to acquire an identification of a player,
wherein the predefined association enabling condition includes at least a condition that the identifications of the one or more players are acquired by the identification acquisition device.

5. The drawing game system according to claim 3, further comprising:
an identification acquisition device configured to acquire an identification of a player,
wherein the predefined association enabling condition includes at least a condition that the identifications of the one or more players are acquired by the identification acquisition device.

6. The drawing game system according to claim 1, further comprising:
an association breaking device configured to break all or part of associations that were made by the association device, in case that a predetermined association breaking condition is satisfied.

7. The drawing game system according to claim 2, further comprising:
an association breaking device configured to break all or part of associations that were made by the association device, in case that a predetermined association breaking condition is satisfied.

8. The drawing game system according to claim 3, further comprising:
an association breaking device configured to break all or part of associations that were made by the association device, in case that a predetermined association breaking condition is satisfied.

9. The drawing game system according to claim 4, further comprising:
an association breaking device configured to break all or part of associations that were made by the association device, in case that a predetermined association breaking condition is satisfied.

10. The drawing game system according to claim 5, further comprising:
an association breaking device configured to break all or part of associations that were made by the association device, in case that a predetermined association breaking condition is satisfied.

11. The drawing game system according to claim 6,
wherein the association breaking device is configured to break all or part of associations that were made by the association device, in case that the predetermined association breaking condition is satisfied,
wherein the predefined association enabling condition includes at least a condition that a predefined specific choice is drawn by the drawing device.

12. The drawing game system according to claim 11,
wherein at least part of choices to be drawn by the drawing device corresponds to a variable reward to be granted by the drawing reward granting device;
wherein the drawing reward granting device is configured to grant the one or more players with the variable reward and to re-set a value of the variable reward into an initial value of the variable reward, in case that the at least part of choices corresponding to the variable reward was drawn by the drawing device; and
wherein the association breaking device is configured to break all or part of associations that were made by the association device, in case that the predetermined association breaking condition is satisfied, which includes at least a condition that the value of the variable reward is re-set by the drawing reward granting device into an initial value of the variable reward.

13. The drawing game system according to claim 7,
wherein the association breaking device is configured to break all or part of associations that were made by the association device, in case that the predetermined association breaking condition is satisfied,
wherein the predefined association enabling condition includes at least a condition that a predefined specific choice is drawn by the drawing device.

14. The drawing game system according to claim 13,
wherein at least part of choices to be drawn by the drawing device corresponds to a variable reward to be granted by the drawing reward granting device;
wherein the drawing reward granting device is configured to grant the one or more players with the variable reward and to re-set a value of the variable reward into an initial value of the variable reward, in case that the at least part of choices corresponding to the variable reward was drawn by the drawing device; and
wherein the association breaking device is configured to break all or part of associations that were made by the association device, in case that the predetermined association breaking condition is satisfied, which includes at least a condition that the value of the variable reward is re-set by the drawing reward granting device into an initial value of the variable reward.

15. The drawing game system according to claim 8,
wherein the association breaking device is configured to break all or part of associations that were made by the association device, in case that the predetermined association breaking condition is satisfied,
wherein the predefined association enabling condition includes at least a condition that a predefined specific choice is drawn by the drawing device.

16. The drawing game system according to claim 15,
wherein at least part of choices to be drawn by the drawing device corresponds to a variable reward to be granted by the drawing reward granting device;
wherein the drawing reward granting device is configured to grant the one or more players with the variable reward and to re-set a value of the variable reward into an initial value of the variable reward, in case that the at least part of choices corresponding to the variable reward was drawn by the drawing device; and
wherein the association breaking device is configured to break all or part of associations that were made by the association device, in case that the predetermined association breaking condition is satisfied, which includes at least a condition that the value of the variable reward is re-set by the drawing reward granting device into an initial value of the variable reward.

17. The drawing game system according to claim 9,
wherein the association breaking device is configured to break all or part of associations that were made by the association device, in case that the predetermined association breaking condition is satisfied,
wherein the predefined association enabling condition includes at least a condition that a predefined specific choice is drawn by the drawing device.

18. The drawing game system according to claim 17,
wherein at least part of choices to be drawn by the drawing device corresponds to a variable reward to be granted by the drawing reward granting device;
wherein the drawing reward granting device is configured to grant the one or more players with the variable reward and to re-set a value of the variable reward into an initial value of the variable reward, in case that the at least part of choices corresponding to the variable reward was drawn by the drawing device; and
wherein the association breaking device is configured to break all or part of associations that were made by the association device, in case that the predetermined association breaking condition is satisfied, which includes at least a condition that the value of the variable reward is re-set by the drawing reward granting device into an initial value of the variable reward.

19. A drawing game method comprising:
drawing for one or more players a choice from among two or more choices;
granting the one or more players with a drawing reward, based at least in part on the choice drawn;
associating the one or more players with the choice drawn; and
granting the one or more players with an association reward, in case that after the choice was associated, the choice has been drawn.

20. A non-transitory computer readable storage medium that stores one or more computer programs, when executed by one or more computers, cause the one or more computers to perform a drawing game method comprising:
drawing for one or more players a choice from among two or more choices;
granting the one or more players with a drawing reward, based at least in part on the choice drawn;
associating the one or more players with the choice drawn; and
granting the one or more players with an association reward, in case that after the choice was associated, the choice has been drawn.
